(19) United States
(12) Patent Application Publication
(10) Pub. No.: US 2005/0118532 A1
(43) Pub. Date: Jun. 2, 2005

(54) Back to Front Alignment with Latent Imaging

(75) Inventors: Hans J. Mallmann, Boppard (DE); Thilo Mueller, Bechtolsheim (DE); Rainer Benczek, Bad Kreuznach (DE)

Correspondence Address: International Business Machines Corporation, New Orchard Road, Armonk, NY, 10504, US

(73) Assignee: INTERNATIONAL BUSINESS MACHINES CORPORATION, Armonk, NY (US)

(21) Appl. No.: 10/904,485

(22) Filed: Nov. 12, 2004

(30) Foreign Application Priority Data
Nov. 14, 2003 (DE) 03104201.3

(51) Int. Cl. G03C 5/00

(52) U.S. Cl. 430/311

(57) ABSTRACT

The invention relates to a method for lateral alignment of a substrate for photolithography, wherein the substrate's back side has a reference mark and the substrate front side is coated with a photoresist. The method includes the steps of: retrieving the reference mark on the substrate's back side, applying an alignment mark on the front side of the substrate by means of a first exposure of the photoresist with electromagnetic radiation to provide an undeveloped alignment mark, the undeveloped alignment mark being laterally positioned on the photoresist with respect to the reference mark on the substrate's back side, aligning the substrate by making use of the undeveloped alignment mark, applying a further manufacturing process on the front side of the aligned substrate.

### BACKGROUND OF THE INVENTION

The present invention relates generally to techniques for aligning an element on a surface of an object, and more specifically to a method, apparatus and computer program product for aligning an element on a semiconductor substrate in accordance with reference marks on the substrate.

A manufacturing process for electronic or micro-mechanical components incorporates a multitude of surface treatment procedures such as chemical etching, coating, laser beam ablation and the like. In order to produce mechanical or electrical surface structures on a micrometer scale or even on a sub-micrometer scale, chemical etching in combination with a mask generated by a photolithographic technique is commonly used. Typically in photolithography, a photo sensitive material coated on a surface of a substrate is exposed with a spatial light pattern in a first step. In a successive step the exposed photoresist is developed in order to create a structured surface of the substrate which is then subject to further process steps of e.g. etching, coating, evaporating or ion implantation.

In the majority of cases, the photolithographic procedure itself only provides a structured mask which is needed for a successive surface treatment procedure, such as etching. Typically, after the appliance of such surface treatment process steps, the photo sensitive layer is completely removed. Typically a photo sensitive layer, a photo resist, only acts as an intermediate medium to provide a spatially structured mask for surface treatment processes.

The entire production process of electronic semiconductor components or micro mechanical components typically makes use of a plurality of coating and etching processes in combination with various lithographic processes. Since the different steps of surface treatment or lithography are separately processed by different devices, a proper and accurate alignment, in particular lateral alignment, is essential and crucial for the quality of the final product. In order to provide and to guarantee a proper layer overlay, alignment marks are applied on the substrate. These alignment marks allow an exact alignment of the substrate for each of the successive manufacturing processes of the electronic semiconductor component. With the help of a visual detection of the position of the alignment mark, the substrate can be exactly laterally aligned prior to execution of successive surface treatment steps.

Alignment marks applied on a layer of photoresist are sometimes insufficient, because a photoresist typically does not reside on the substrate during the entire production process. Hence the alignment mark only survives a limited number of process steps.

In order to overcome the insufficiency of temporary alignment marks, permanent reference marks have been introduced on the back side of a substrate. Since the alignment of a substrate with a back side reference mark is rather costly and involves a whole imaging apparatus of the substrate's back side, it is desirable to project the permanent reference mark of the back side of the substrate to the front side of the substrate, which is subject to surface treatment.

U.S. Pat. No. 5,361,132 discloses a back to front alignment of elements on a substrate. This back to front alignment technique makes use of a pair of grating elements having a reference center line there between provided on the front surface thereof, the reference center line being at a known position relative to the features present on such surface, which features are to be replicated in an aligned fashion on the opposite or back surface of the substrate. A beam of electromagnetic energy is applied to the grating elements so as to generate an interference fringe pattern having a reference center bright space on the opposite surface of the substrate, the center bright space corresponding to, and being aligned with the reference center line of the grating elements on the front side. The position of the center reference bright space of the interference fringe pattern is determined and a corresponding reference marker or a mask element having the locations of the desired features suitably placed thereon is aligned therewith using a suitable alignment system.

Since this method is based on the generation of interference fringe patterns on the opposite surface of the substrate, the substrate has to be transparent. Therefore, this method cannot be applied to non-transparent substrates or layers.

U.S. Pat. No. 5,338,630 discloses a photolithography controlled method. This control method makes explicit use of a so-called latent image which is exposed but remains undeveloped in the photosensitive layer. The method includes the steps of loading a wafer having a layer of photoresist into a photolithography system, exposing the photoresist in accordance with an initial set of control parameters including exposure time, (providing exposure energies), position of the wafer within the photolithography system and focus. Prior to developing the photoresist, optical characteristics of the exposed photoresist are observed by a phase contrast microscope which detects latent images. Then, according to the observations of the latent image, the initial set of control parameters is adjusted to generate a second set of control parameters.

### SUMMARY OF THE INVENTION

In accordance with the present invention, a method for alignment of a substrate is provided. The substrate has a reference mark and at least a part of the surface of the substrate is coated with a photoresist. The method includes the steps of, retrieving the position of the reference mark, applying an alignment mark by means of a first exposure of the photoresist, where the alignment mark being positioned on the photoresist in accordance with the position of the reference mark, and aligning the substrate in accordance with the alignment mark.

These and other aspects of the present invention will be better appreciated and understood when considered in conjunction with the following description and the accompanying drawings, which are not necessarily drawn to scale.

### BRIEF DESCRIPTION OF THE DRAWINGS

FIG. 1 illustrates a cross section of a substrate with reference and alignment marks.

FIG. 2 illustrates a flow chart of the alignment method of the invention.

FIG. 3 shows a developed alignment mark.

FIG. 4 illustrates a top view of a substrate with a permanent reference notch and two temporary alignment marks.

### DETAILED DESCRIPTION OF THE PREFERRED EMBODIMENTS

The invention provides a method for alignment, such as lateral alignment, of a substrate in a photolithography process. The substrate's back side preferably has a reference mark and the substrate's front side is coated with a photoresist.

An alignment mark is applied on the front side of the substrate on the basis of the position of the reference mark on the substrate's back side.

Firstly, the position of the reference mark is retrieved on the substrate's back side. Preferably, the reference mark on the substrates back side is visible so that its position can be detected by an appropriate imaging or image processing system. After the position of the reference mark is determined, a alignment mark is applied on the front side of the substrate by means of a first exposure of the photoresist on the front side of the substrate. The position of this alignment mark is calculated on the basis of the determined position of the reference mark on the back side of the surface.

The alignment mark is preferably generated by a short exposure of the photoresist which leads to a structural or optical changes of the photoresist that can be detected visually or by means of optical phase contrast, for example, without developing the exposed layer of photoresist. Since the alignment mark on the front side of the substrate can be detected, the alignment of the substrate can be performed with high accuracy prior to developing the photoresist. Once an alignment of the substrate has been performed, successive surface treatment processes, such as an additional exposure of the photoresist can take place.

The position of the substrate is determined on the basis of the position of the undeveloped alignment mark, such as a latent image of the alignment mark. The position of the undeveloped alignment mark can be determined by means of an optical imaging system in combination with an image processing system. Depending on the type of photoresist, a structural change in the photoresist, which is due to the first exposure can be detected visually or e.g. by making use of phase contrast imaging methods. In both cases, the position of the alignment mark can preferably be determined without developing of the first exposure.

Making use of the undeveloped alignment mark, such as a latent image, for the purpose of alignment of a substrate is advantageous in the sense, that a development step in which the alignment mark is developed, can be skipped. In this way the number of steps for a conventional alignment procedure making use of an alignment mark can be reduced, because the intermediate development step for visualizing the alignment mark can be left out. It is obvious, that the utilization of latent imaging provides a time and cost reduction for the entire manufacturing process. This kind of economization is indeed appreciable, because alignment processes in combination with photolithography have to be performed several times during a manufacturing process.

Since the method of the present invention generates an alignment mark on the front side of the substrate, such an imaging system for the detection of the position of the reference mark is only required once as long as the alignment mark resides on the front side of the substrate. Only a distinct apparatus that generates the latent image on the front side of the substrate requires an optical means, such as an image processing system, for the detection of the position of the reference mark on the substrate's back side.

The reference mark may be a notch somewhere in the circumference of the substrate. In this way the determination of the position of the reference mark can be simplified, because an imaging system of the substrates back side is not necessarily needed. For example, the position of the reference mark can be determined by an optical system which is located on the same side of the substrate as the optical system for the exposure of an alignment mark. Preferably the optical systems for detecting the position of the reference mark and for exposing the alignment mark are incorporated in one optical system. This decreases the operative complexity of the entire alignment and manufacturing system.

In the preferred embodiment of the invention, transparent as well as non-transparent substrates can be used. Since the position of the reference mark on the back side of the substrate is determined by an optical imaging system which is located below the substrate, i.e. near the back side of the substrate, the substrate does not have to be transparent in order to apply the latent image on the photoresist on the front side of the substrate. This means, that the position of the reference mark is retrieved from the back side and the latent image is exposed on the photoresist from the front side of the substrate.

The photoresist on the front side of the substrate may be subject to a second exposure with electromagnetic radiation prior to developing the undeveloped alignment mark. Therefore, an intermediate step of developing an exposed alignment mark can be left out. Due to the fact, that the exposed, but undeveloped alignment mark is either directly visible or can effectively be detected by means of optical phase contrast techniques, a proper and accurate alignment of the substrate can be provided before an additional exposure of the photoresist takes place.

Further according to the aforementioned embodiment of the invention, the alignment mark as well as the desired spatial pattern can be applied on the same photoresist without performing an intermediate development step. Since the invention provides a skipping of such an intermediate development process, the number of process steps required for the entire manufacturing of the product reduced. Such a reduction of process steps saves time and cost.

According to the embodiment of the invention, the alignment mark of the first exposure as well as a spatial pattern of the second exposure are developed simultaneously in a successive development step. After such a development process step, both the developed alignment mark as well as the desired spatial pattern are directly visible on the front side of the substrate. Once, the substrate has been prepared in this way it can be subject to successive process steps of e.g. chemical etching, ion implantation or coating. For these successive process steps, the developed alignment mark serves as a means for aligning the substrate and the developed spatial pattern of the second exposure serves as a mask.

According to the embodiment of the invention, the alignment mark can be applied on the front side of the substrate in a predefined way, i.e. its relative position with respect to the position of the permanent reference mark on the back side of the substrate can be defined according to a user's specification.

The relative position of the alignment mark with respect to the reference mark may be defined depending on a type of substrate. In this way the method can be universally applied to various types of substrates having a different surface structure and therefore require different positions of an alignment mark. When for example a first substrate requires a surface treatment in its central area and when a second substrate requires surface treatment near the edges of its surface, the alignment mark for the first substrate can be applied near the edge of the substrate while the alignment mark of the second substrate can be applied in the central area of the substrate.

The alignment marks are preferably applied to such portions of the surface of the substrate that are irrelevant for the successive manufacturing processes. For example, various substrates supported by a supplier having the same reference mark on the substrate's back side, can be universally used for the manufacturing of different electronic components with a different surface structure and hence requiring different alignment marks during the manufacturing process.

The spatial structure of the alignment mark can be designed in an arbitrary way. For example, the alignment mark may be same as that of a reference mark on the back side of the substrate. Alternatively it may be an arbitrary geometric structure such as a cross, a circle, a square or some other geometrical object serving as a reticle.

A plurality of alignment marks may be applied on the front side of the substrate. Each of the plurality of alignment marks may have a different lateral position. The plurality of alignment marks may be applied on the photoresist by means of a single or by means of a plurality of exposures with electromagnetic radiation. Since the exposed alignment marks are not developed prior to a second exposure applying a spatial pattern on the photoresist, the different alignment marks can be applied in a sequential way.

Since the single alignment marks on the front side of the surface comprise a relative lateral distance, not only the positioning but also the orientation of the substrate can be performed in an easy and efficient way. When in contrast the alignment of a substrate is performed by means of a single alignment mark, an accurate orientation of the substrate requires that the geometrical structure of the alignment mark has to be taken into account.

In this case the alignment marks do not require a distinct geometrical structure. For example in a very simple case the two alignment marks may be implemented as dots or circles that are easy to produce and easy to detect.

The invention therefore provides an efficient approach for back to front alignment of a substrate for a lithography process. Since an alignment mark is applied on the front side of the substrate by making use of a permanent reference mark on the substrate's back side, the permanent reference mark has only to be retrieved by a limited number of process steps during the manufacturing of an electronic or micro-mechanic product. This is of extreme advantage because a stepper performing the second exposure and thereby applying a high resolution spatial pattern on the photoresist does usually not comprise means for retrieving reference marks that are located on the back side of a substrate.

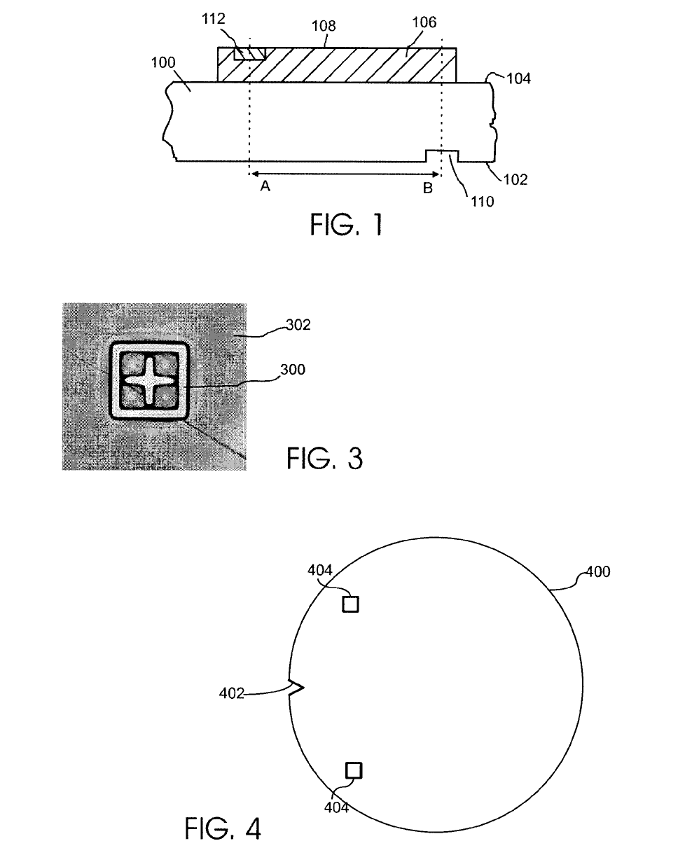

FIG. 1 shows a side view of a substrate 100 having a back surface 102 and front surface 104. The substrate 100 is coated with a photoresist 106 on the front surface 104. The photoresist 106 has a surface 108 as well as an alignment mark 112. The back surface 102 of the substrate 100 has a reference mark 110.

The reference mark 110 located at the back side of the substrate may be a notch. The lateral position B of the reference mark 110 can be retrieved by optical means, e.g. a backside microscope. Depending on the lateral position of the permanent reference mark 110 on the backside of the substrate 102, a lateral position A of the alignment mark 112 to be applied on the photoresist 106 is determined. The lateral distance between the positions of the alignment mark A and the reference mark B can be adapted according to the specifications of the manufacturing process.

The alignment mark 112 is applied on the photoresist 106 by a short exposure of the surface of the photoresist 108 by means of electromagnetic radiation. Since the lateral distance between the alignment mark 112 and the reference mark 110 is somehow specified, the alignment mark 112 in the form of the latent image is utilized for an accurate alignment of the substrate 100 for successive surface treatment processes in the framework of the manufacturing of an electronic or micro-mechanical component.

The first exposure of the photoresist resulting in the generation of the alignment mark 112 induces a local structural change of the photoresist in the area of the alignment mark 112 to form a latent image of the alignment mark. The latent image can be either directly visible or visualized by optical means, e.g. an optical phase contrast technique. In this way, the position “A” of the alignment mark 112 and hence the position of the substrate 100 can be determined in an accurate way for the purpose of successive treatment of the surface 108 of the photoresist and/or further treatment of the surface 104 of the substrate 100.

When the substrate 100 has been properly aligned, a second exposure of the surface 108 of the photoresist layer 106 can take place. By means of this second exposure, a lateral spatial structure is applied in the photoresist 106. The structural changes of the photoresist 106 that are due to the second exposure penetrate the photoresist 106 up to the surface 104 of the substrate 100. During the proceeding developing process, the alignment mark 112 as well as the applied spatial structure of the second exposure are developed by removing exposed or unexposed portions of the photoresist 106.

The developed photoresist then serves as a mask for further surface treatment of the surface 104 of the substrate 100. During further process steps, the entire photo resist 106 including the alignment mark 112 may be removed. In such a case the reference mark 110 on the backside of the substrate 100 can again be used to specify the position and orientation of the substrate 100. In combination with an additional coating of the surface 104 of the substrate 100 with a photoresist layer, the described procedure of producing an alignment mark 112 can be applied repeatedly.

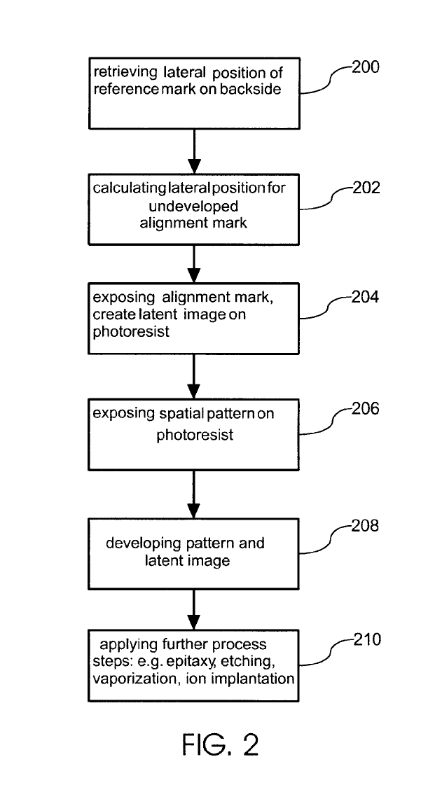

FIG. 2 illustrates a flow chart of the alignment method of the present invention. The method is preferably performed by using a system including an image processing systems for observing a reference mark and an alignment mark, a system for positioning a substrate, an optical system for exposing a photoresist, a computer for controlling these systems and so on. In a first step 200 the lateral position of the reference mark located on the back side of the substrate is retrieved by, for example, a known image processing system. Depending on this retrieved position, in a next step 202 a lateral position for the alignment mark is calculated by a central processing unit of a computer for example. This calculation can be based on process or user specifications, requiring a defined lateral distance between the reference mark on the back side and the alignment mark on the front side of the substrate.

In the next step 204, the photoresist is subject to a first exposure in which the alignment mark is applied in the photoresist. In this way the alignment mark 112 which may be a latent image is created which is detectable by optical means without developing of the photoresist. Based on the applied alignment mark 112 in form of the latent image, the substrate can be aligned before successive process steps are applied. In the step 206, a successive process step in form of a second exposure is applied on the photoresist. Preferably, this type of exposure provides a high resolution spatial pattern on the photoresist which serves as a mask for further surface treatment processes after developing. This second exposure is typically performed by a stepper or scanner that has no means to retrieve the reference mark on the substrate's back side. After the second exposure of the photoresist has been performed in step 206, the exposed photoresist is developed in the next step 208. In this step the alignment mark as well as the spatial pattern formed by the second exposure are developed simultaneously.

Developing step may comprises removing exposed or unexposed portions of the photoresist. In this way a mask is generated which is used for further surface treatment processes like epitaxy, etching, vaporisation or ion implantation. The plurality of different surface treatment processes requiring a mask generated by photolithography are summarized in step 210.

FIG. 3 shows one example of an image of an alignment mark 300. The alignment mark 300 has a geometrical structure incorporating a square and a cross. In this example, an alignment mark 300 is directly visible due to its different brightness than the background 302. The background 302 can either be developed photoresist or the front surface of the substrate.

Since the alignment mark 300 has a non-circular symmetry, the substrate can be positioned as well as orientated by means of a single reference mark 300.

FIG. 4 shows a top view of another example of a substrate 400 having a reference mark 402 and two alignment marks 404. The mark 402 is preferably a notch in the substrate 400 so that the location of the mark 402 as a reference mark can be detected from either front- or back side of the substrate. In such a case, a back side microscope for the determination of the position of the permanent reference mark is not needed.

The position of the reference mark 402 can therefore be determined by optical means from the front side of the substrate 400. Furthermore the figure illustrates two alignment marks 404 that are located at different positions on the substrate 400. In this case the latent images 404 have a rectangular shape. An accurate and proper alignment of the substrate 400 can be performed with respect to the positions of the two alignment marks 404. An analysis of the geometrical structure of a latent image 404 is not required. In such a case the geometrical structure of a latent image 404 can be very simple and may even have a circular symmetry.

While the invention has been described in terms of specific embodiments, it is evident in view of the foregoing description that numerous alternatives, modifications and variations will be apparent to those skilled in the art. Accordingly, the invention is intended to encompass all such alternatives, modifications and variations which fall within the scope and spirit of the invention and the following claims.

1. A method for alignment of a substrate having a reference mark wherein at least a part of the surface of the substrate is coated with a photoresist, the method comprising the steps of:
retrieving the position of the reference mark;
applying an alignment mark by means of a first exposure of the photoresist, the alignment mark being positioned on the photoresist in accordance with the position of the reference mark;
aligning the substrate in accordance with the alignment mark.

2. The method according to claim 1, wherein the aligning step further comprises a step of optically observing the alignment mark.

3. The method according to claim 1, wherein the position of the reference mark is determined in accordance with an optical observation.

4. The method according to claim 1, wherein the first exposure is performed by electromagnetic radiation and the substrate is non-transparent for the applied electromagnetic radiation.

5. The method according to claim 1, further comprising the steps of:
applying a pattern on the photoresist by means of a second exposure of the photoresist with electromagnetic radiation;
developing the pattern and the alignment mark.

6. An apparatus for aligning a substrate, the substrate having a reference mark and at least a part of whose surface is coated with a photoresist, the apparatus comprising:
a unit for retrieving the position of the reference mark;
a unit for applying an alignment mark on the photoresist, the alignment mark being positioned in accordance with the position of the reference mark;
a unit for aligning the substrate in accordance with the alignment mark.

7. The apparatus according to claim 6, further comprising a unit for determining the position of the substrate by optically observing the alignment mark.

8. The apparatus according to claim 6, further comprising:
a unit for applying a pattern on the photoresist;
a unit for developing the pattern and the alignment mark.

9. A substrate for photolithography, wherein the substrate's back side has a reference mark and the substrate's front surface is coated with a photoresist, the substrate comprising an undeveloped alignment mark generated by a first exposure of the photoresist with electromagnetic radiation, the position of the undeveloped alignment mark is detectable by optical means.

10. The substrate according to claim 9, wherein the optical means for determining the position of the undeveloped alignment mark comprise visual detection or means for measuring an optical phase contrast.

11. A computer program product comprising a computer usable medium tangibly embodying computer readable program code means for directing a computer to align a substrate, the substrate having a reference mark and at least a part of the surface of the substrate being coated with a photoresist, the computer program product comprising:
code means for directing the computer to retrieve the position of the reference mark;
code means for directing the computer to apply an alignment mark on the photoresist, the alignment mark being positioned in accordance with the position of the reference mark;
code means for directing the computer to align the substrate in accordance with the alignment mark.

12. The computer program product according to claim 11, further comprising code means for directing the computer to determine the position of the substrate by optically observing the alignment mark.

13. The computer program product according to claim 11, further comprising code means for directing the computer to determine the position of the reference mark on the substrate on the basis of optical observation.

14. The computer program product according to claim 11, further comprising:
code means for directing the computer to apply a pattern on the photoresist by means of a second exposure of the photoresist with electromagnetic radiation,
code means for directing the computer to develop the and the alignment mark.
